(19) United States
(12) Patent Application Publication
(10) Pub. No.: US 2021/0307201 A1
(43) Pub. Date: Sep. 30, 2021

(54) METHOD FOR DESIGNING CHANNEL STRUCTURE OF PULSATING HEAT PIPE AND HEAT DISSIPATION DEVICE USING THE SAME

(71) Applicant: KOREA ADVANCED INSTITUTE OF SCIENCE AND TECHNOLOGY, Daejeon (KR)

(72) Inventors: Sung Jin Kim, Daejeon (KR); Jong Hyun Lim, Daejeon (KR)

(21) Appl. No.: 17/211,249

(22) Filed: Mar. 24, 2021

(30) Foreign Application Priority Data
Mar. 31, 2020 (KR) 10-2020-0039305

(51) Int. Cl. H05K 7/20; G06F 30/17; G06F 30/28

(52) U.S. Cl. CPC H05K 7/20336; G06F 2111/04; G06F 30/28; G06F 30/17

(57) ABSTRACT

The present disclosure relates to a method for designing a channel structure of a pulsating heat pipe and a heat dissipation device using the same. The pulsating heat pipe may have the channel structure designed such that at least some channels of the plurality of channels are merged and channels of which the number is greater than the half of the plurality of channels overlap at least partially with the heating portion area. The heat dissipation device may efficiently perform heat dissipation in a local heating condition.

### CROSS REFERENCE TO RELATED APPLICATIONS

The present application claims priority to Korean Patent Application No. 10-2020-0039305 filed Mar. 31, 2020, the entire contents of which is incorporated herein for all purposes by this reference.

### BACKGROUND

The most important factor in determining the performance and lifetime of an electronic device is temperature. Rapid increase in the temperature of the electronic device may degrade the performance thereof and cause the rapid decrease in the longevity thereof.

Recently, electronic devices are rapidly developing and changing in various forms. They are gradually becoming thinner and are changing innovatively, for example, requires flexibility, etc. These innovative changes imply a high heating value.

The high heating value of the electronic device increases the temperature of the electronic device. This may cause great risk in terms of operation of the electronic device or safety for users. If the temperature of the electronic device is not appropriately controlled, the performance of the electronic device cannot be maximized. Also, this may cause failure due to thermal damage and fatal problems such as a low temperature burn to users, etc.

Therefore, the internal temperature problem must be solved through thermal management by introducing a heat dissipation device effective to the electronic device.

A heat pipe, an existing widely used heat dissipation device, has a complicated wick structure therewithin, so that it has a limitation in being applied to the next very thin or bendable generation electronic device.

A flat pulsating heat pipe (PHP) which is thin and capable of providing a high thermal performance is proposed as an alternative capable of overcoming such a limitation.

### SUMMARY

The proposed pulsating heat pipe has a limitation in performing effective heat dissipation in a local heating condition.

Various embodiments of the present disclosure provide a channel structure of the pulsating heat pipe, which is capable of causing an active pulsating motion of a working fluid over the entire channel even in a local heating condition.

Various embodiments of the present disclosure provide a method for manufacturing the above-described channel structure of the pulsating heat pipe.

Various embodiments of the present disclosure provide a heat dissipation device which adapts the above-described channel structure of the pulsating heat pipe and performs heat dissipation and provide an electronic device including the same.

The technical problem to be overcome in this document is not limited to the above-mentioned technical problems. Other technical problems not mentioned can be clearly understood from those described below by a person having ordinary skill in the art.

The (?) embodiment is a method for designing a channel structure of a pulsating heat pipe. The method includes performing an initial setting including setting a heating portion, setting a design area for designing a channel structure around the heating portion, setting a boundary condition of the design area, dividing the design area into a large number of elements, and setting a relative density for each element as an optimization parameter; setting an objective function for minimizing a temperature difference between the heating portion and the boundary of the design area, a relative density constraint that the relative density has a value greater than or equal to 0 and is less than or equal to 1, a sensitivity filter for controlling a channel width which is set within the design area to a predetermined channel width, a total void volume constraint that a total void volume fraction which means a channel wall portion must be greater than a predetermined value for the purpose of structural safety of the pulsating heat pipe, and a local void volume constraint for suppressing the merging of the channel in the heating portion; obtaining a temperature distribution vector of the plurality of element areas based on each of the element areas; calculating the object function and a sensitivity of the objective function; updating the relative density of the plurality of element areas by performing optimization based on the set constraints and the set objective function, and finding a new relative density which minimizes thermal compliance; determining whether the relative density constraint, the sensitivity filter, a total void volume constraint and a local void volume constraint are satisfied; calculating again, when the constraints are not satisfied, temperatures in the plurality of element areas based on the updated relative density; arranging, as the channel wall, when the set constraint is satisfied, the element areas where the relative density is less than a threshold value among the plurality of element areas; and merging the channel of a condensing portion based on the merging of the channel created by arranging the channel wall.

According to various embodiments of the present disclosure, a heat dissipation device may include the pulsation heat pipe having the channel structure designed according to the above method for designing the channel structure.

According to various embodiments of the present disclosure, an electronic device may include a heat source which radiates heat for operations thereof and the heat dissipation device which includes the pulsating heat pipe having the channel structure designed according to the foregoing methods in order to dissipate the heat from the local heat source.

According to various embodiments, through use of the channel structure of the pulsating heat pipe proposed in the present disclosure, it is possible to efficiently perform heat dissipation in a local heating condition such as main IC chips of the electronic device.

Advantageous effects that can be obtained from the present disclosure are not limited to the above-mentioned effects. Further, other unmentioned effects can be clearly understood from the following descriptions by those skilled in the art to which the present disclosure belongs.

### BRIEF DESCRIPTION OF THE DRAWINGS

FIG. 1 shows an example of a pulsating heat pipe (PHP);

FIG. 2 shows examples of a channel structure of the pulsating heat pipe proposed in the present disclosure which is configured such that all the channels come at least partially into contact with a heating portion;

FIG. 3 shows a process of obtaining a geometric shape by simplifying the channel of the heating portion;

FIG. 4 shows the channel structure in the heating portion and the simplified geometric shape obtained for each channel structure in accordance with FIG. 3;

FIG. 5 shows two reference channel structure shapes and values of turning functions of the shapes;

FIG. 6 shows geometric shapes corresponding to various non-uniform channel structures;

FIG. 7 shows dissimilarities 1 and 2 for the geometric shapes of FIG. 6 and thermal conductivity according to effective dissimilarities;

FIG. 8 shows an example of the designed pulsating heat pipe 100;

FIG. 9 is a flowchart showing an operation to design the channel structure of the pulsating heat pipe 100;

FIG. 10 shows an example in which the heating portion 111 has a very small size;

FIG. 11 is a view for describing a topology optimization method;

FIG. 12 shows an example of setting a boundary condition and a design area applied to the topology optimization method for a thermal conduction path design;

FIG. 13 shows an example of an operation method of a local void volume constraint;

FIG. 14 shows a method for designing the channel structure of the pulsating heat pipe based on the topology optimization method;

FIG. 15 shows a history of a relative density distribution which appears during the optimization;

FIG. 16 shows the channel arrangement according to a topology optimization result in the design area 210; and

FIG. 17 shows the pulsating heat pipe 200 in which the channel arrangement has been made based on the topology optimization method.

With regard to the description of the drawings, the same or similar reference numerals may be used for the same or similar components.

### DETAILED DESCRIPTION

Hereinafter, embodiments disclosed in this specification will be described in detail with reference to the accompanying drawings. The same or similar elements will be denoted by the same reference numerals irrespective of drawing numbers, and repetitive descriptions thereof will be omitted.

Also, in the following description of the embodiment disclosed in the present specification, the detailed description of known technologies incorporated herein is omitted to avoid making the subject matter of the embodiment disclosed in the present specification unclear. Also, the accompanied drawings are provided only for more easily describing the embodiment disclosed in the present specification. The technical spirit disclosed in the present specification is not limited by the accompanying drawings. All modification, equivalents and substitutes included in the spirit and scope of the present invention are understood to be included in the accompanying drawings.

While terms including ordinal numbers such as the first and the second, etc., can be used to describe various components, the components are not limited by the terms mentioned above. The terms are used only for distinguishing between one component and other components.

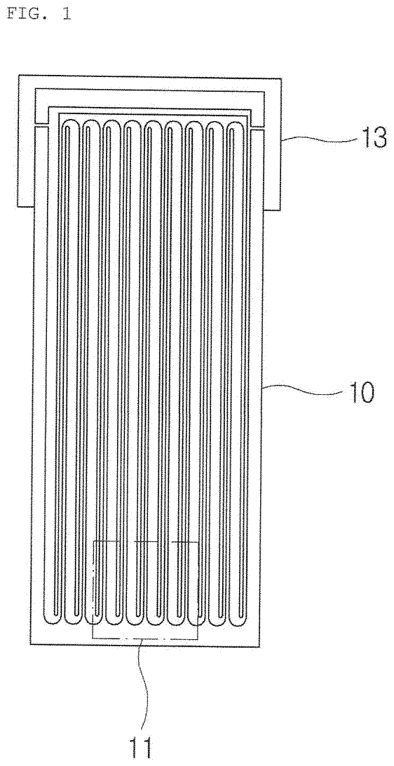

FIG. 1 shows an example of a pulsating heat pipe (hereinafter, referred to as PHP).

Referring to FIG. 1, unlike other existing heat dissipation devices, the PHP 10 is composed of channels connected to each other in a smooth form without an internal wick structure, and a portion of the internal volume of the channel is filled with working fluid.

When the hydraulic diameter of the channel of the PHP 10 is equal to or less than a certain value, the working fluid filled in the channel is configured in the form of a slug-train, and pulsates due to a difference in vapor pressure by phase change of the working fluid. Due to such pulsation, the heat can be effectively transferred from the heating portion 11 to a condensing portion 13 without the wick structure. Accordingly, the PHP 10 may have a thin flat plate shape.

The working fluid of the PHP 10 can pulsate only through the channel, and this pulsating motion may be caused by heat. Therefore, liquid slugs in the channels away from a heat source may not pulsate actively.

Therefore, the PHP 10 has a limitation in a local heating condition. A conventional PHP 10 is composed of a bundle of channels uniformly arranged as shown in FIG. 1, and the working fluid pulsates along the channels. However, in the case of an electronic device such as a mobile device, in general, the heating portion 11 is limited to a chip size, and the condensing portion 13 is often larger than the chip size. Under this condition, only a portion of the channel of the PHP 10 comes into contact with the heating portion 11, and the remaining part operates without contacting the heating portion 11. Then, an operation principle of the PHP which transfers heat due to a difference in gas pressure by evaporation and condensation caused by heat may not operate properly. That is, the heat is not supplied because of not contacting the heat source, so that pulsation due to the difference in gas pressure may not occur easily, and heat transfer may be inefficiently performed.

Thompson et al. (S M Thompson, H B Ma, Effect of localized heating on three-dimensional flat plate oscillating heat pipe, Adv. Mech. Eng. 2010) presents the results of a study on the effect of the PHP 10 on local heating condition. It was observed that, when local heating is applied, that no pulsating occurs in the channel which does not contact with the heating portion. As a result, it can be seen that the thermal performance was decreased by about 40% compared to the case where the heating portion is uniformly configured over the entire channel and the normal operating range was also decreased by about 50%. Therefore, for effective heat dissipation, it is necessary to cause active pulsating motion of the working fluid over the entire channel even under the local heating condition. To this end, the present disclosure proposes a channel structure of the pulsating heat pipe as a first embodiment, in which some channels are merged so that all channels come into contact with the heating portion.

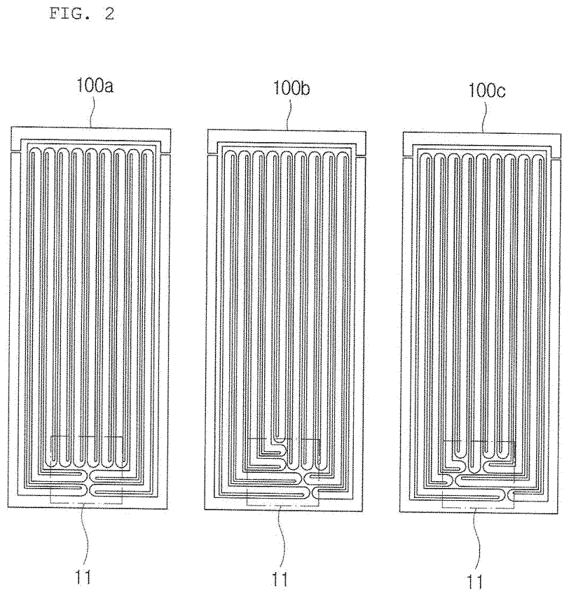

FIG. 2 shows examples of a channel structure of the pulsating heat pipe proposed in the present disclosure which is configured such that all the channels come at least partially into contact with the heating portion.

Referring to FIG. 2, the pulsating heat pipes (PHPs) 100a, 100b, and 100c proposed in the present disclosure have a common point in that all the channels contact with the heating portion 11 even if the pulsating heat pipes have different channel structures. With the channel structure shown in FIG. 2, heat generated by the heating portion 11 may be supplied to all the channels of the PHPs 100a, 100b, and 100c. However, since the sizes of respective channel's surface in contact with the heating portion 11 are different, the PHP may have a non-uniform thermal configuration in which the amount of the heat supplied to each channel of the PHPs 100a, 100b, and 100c is not uniform.

Based on the channel structure proposed in the present disclosure, even if all the channels contact with the heating portion 11, the thermal performance which is different according to the channel structure may be provided.

In order to quantify the thermal performance effect according to the channel structure, the concept of effective dissimilarity is proposed.

Dissimilarity is a concept that quantitatively indicates how much different two geometric shapes are. The dissimilarity may be determined by the difference between the turning functions of the two geometric shapes. Here, the turning function is a method of defining a polygon in a matrix proposed by Arkin et al. The turning function proposed by Arkin et al. is described well in reference documents (E M Arkin, L P Chew, D P Huttenlocher, K. Kedem, J S B Mitchell, An efficiently computable metric for comparing polygonal shapes, IEEE Trans. Pattern Anal. Mach. Intell. 13 (1991)). According to this, the turning function θ(s) of the geometric shape may be represented as a change in the counterclockwise turning angle from a reference axis according to the normalized arc length. In addition, the dissimilarity between the two geometric shapes may be defined based on the difference between the two turning functions according to equation 1 below.

[Equation 1]

Here, d(A, B) represents the dissimilarity between geometric shapes A and B, θ_{A}(s)

d(A,B)=[∫₀¹{θ_{A}(s)−θ_{B}(s)}²dr]^{1/2}

represents the turning function of the geometric shape A, θ_{B}(s) represents the turning function of the geometric shape B, and r represents the normalized arc length.

In order to apply the above-described dissimilarity concept to the PHP, it is necessary to obtain the geometrical shape of the channel in the heating portion 11. According to the embodiment, the geometric shape may be obtained from a simplified channel structure.

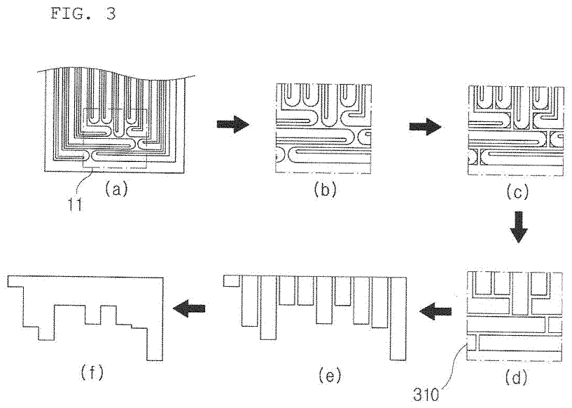

FIG. 3 shows a process of obtaining a geometric shape by simplifying the channel of the heating portion.

Referring to FIG. 3, (b) of FIG. 3 is formed by cutting out only a part in contact with the heating portion 11 in (a) of FIG. 3. In (c) of FIG. 3, a simplified channel structure shown in (d) of FIG. 3 is obtained by drawing a polygon surrounding a pair of a wide channel and a narrow channel connected by turn. Next, the polygons found by searching from a bottom left polygon 310 in a clockwise direction are sequentially arranged to form a shape (e). The process of forming the shape (e) is only an example, and according to another embodiment, the shape (e) may be formed by sequentially arranging the first polygon selected randomly and polygons found by searching in a clockwise or counterclockwise direction. In this case, an area occupied by each polygon may be the same as an area of a rectangle representing the pair of corresponding channels shown in (e) of FIG. 3. Then, the shapes shown in (e) may be combined to finally obtain a geometric shape shown in (f) of FIG. 3.

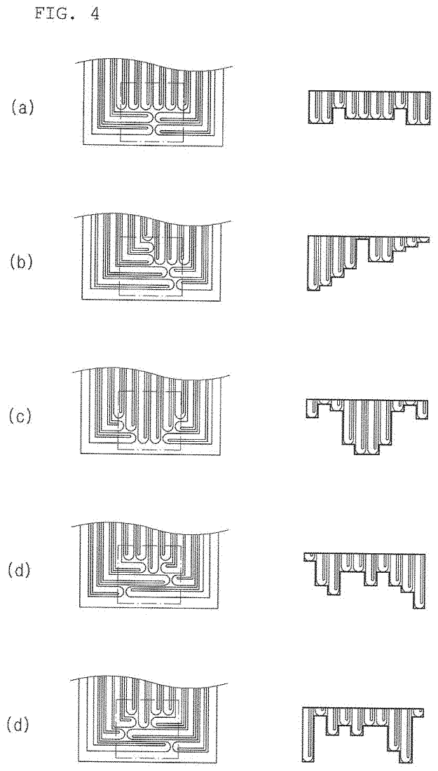

FIG. 4 shows the channel structure in the heating portion 11 and the simplified geometric shape obtained for each channel structure in accordance with FIG. 3.

Referring to FIG. 4, it can be seen that different corresponding geometric shapes can be obtained depending on how the channel structure in the heating portion 11 is configured.

As described above, the PHPs 100a, 100b, and 100c proposed in the present disclosure may have a non-uniform thermal configuration for each channel. Compared to a conventional straight PHP 10, the non-uniform thermal configuration is able to provide improved thermal performance (reference documents: D. Mangini, M. Mameli, D. Fioriti, S. Filippeschi, L. Araneo, M. Marengo, Hybrid pulsating heat pipe for space applications with non-uniform heating patterns: Ground and microgravity experiments, Appl. Therm. Eng. 126 (2017) 1029-1043.).

Also, it has been reported that when the heating power supplied to each channel decreases sequentially, the circulation of the working fluid can improve the thermal performance of the PHP (S. Khandekar, N. Dollinger, M. Groll, Understanding operational regimes). of closed loop pulsating heat pipes: an experimental study, Appl. Therm. Eng. 23 (2003) 707-719.).

The above-described two trends that may affect the thermal performance of the pulsating heat pipe can be quantified by using the dissimilarity between the geometric shape of the channel and two reference channel structure shapes.

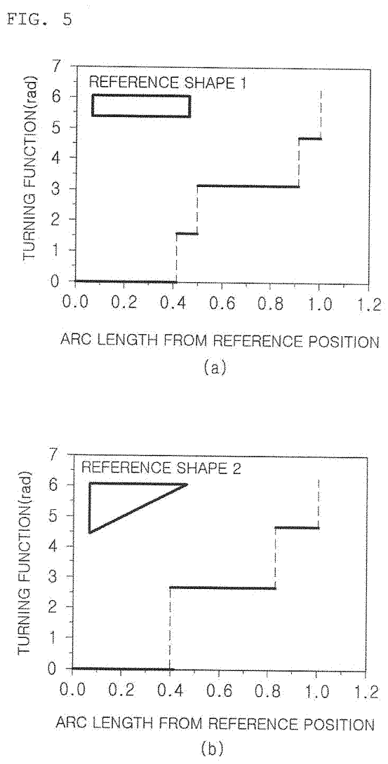

FIG. 5 shows two reference channel structure shapes and values of turning functions of the shapes.

The reference shape 1 shown in (a) of FIG. 5 is a uniform arrangement structure in which heat is evenly applied to all channels. The reference shape 2 shown in (b) of FIG. 5 is a channel arrangement structure in which the heating power supplied to each channel gradually decreases.

Equation 1 can be used to determine the dissimilarity between the geometric shape of each channel structure shown in FIG. 4 and the two reference channel structure shapes shown in FIG. 5. The dissimilarity 1 (d₁) is determined by the difference between the geometric shape of the channel structure and a rectangle representing the reference shape 1. The dissimilarity 2 (d₂) is determined by the difference between the geometric shape of the channel structure and a triangle representing the reference shape 2. The dissimilarity 1 (d₁) indicates how much different the channel structure is from the structure in which the channels are uniformly arranged, and dissimilarity 2 (d₂) indicates how much different the channel structure is from the channel arrangement structure in which the heating power supplied to each channel gradually decreases. Accordingly, the larger the dissimilarity 1 (d₁) is, the more non-uniformly the channels are arranged. In addition, it means that as the dissimilarity 2 (d₂) becomes smaller, the PHP has an arrangement structure which is more similar to the channel arrangement structure in which the heating power supplied to each channel gradually decreases.

Also, the effective dissimilarity (d_{eff}) for quantifying the thermal performance effect according to the channel structure proposed in the present disclosure may be, as shown in equation 2 below, defined as a ratio of the dissimilarity 1 (d₁) and the dissimilarity 2 (d₂) based on the above-described experimental trend.

$${d}_{eff} = \frac{{d}_{1}}{{d}_{2}} \qquad [ Equation 2 ]$$

Based on the above-described trend, it is expected that the thermal performance of the PHP will increase under a local heating condition as the effective dissimilarity (d_{eff}) increases.

In order to check the effectiveness of the effective dissimilarity, the thermal performance and the effective dissimilarity for various channel structures are compared through experiments.

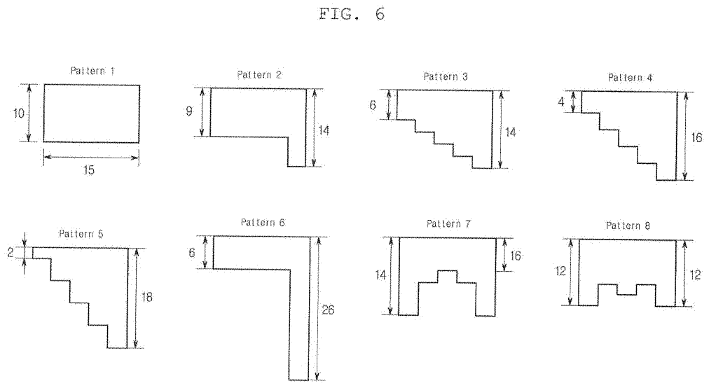

FIG. 6 shows geometric shapes corresponding to various non-uniform channel structures.

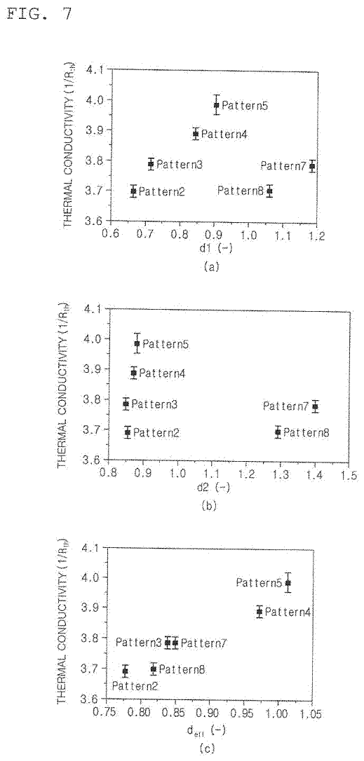

FIG. 7 shows the dissimilarities 1 and 2 for the geometric shapes of FIG. 6 and thermal conductivity according to the effective dissimilarities.

In FIG. 6, a pattern 1 is the reference shape 1 showing uniform heating. In a pattern 6, due to the concentration of the heating power on a specific channel, a local drying phenomenon occurs in the specific channel, thereby reducing the thermal performance of the PHP to show the minimum thermal performance.

As shown in (a) of FIG. 7, a pattern 7 has a higher dissimilarity 1 (d₁) than that of a pattern 3, which means that the heating power is applied more non-uniformly in the pattern 7 than in the pattern 3. Meanwhile, as shown in (b) of FIG. 7, the pattern 3 has a lower dissimilarity 2 (d₂) than that of the pattern 7. This means that the pattern 3 is more advantageous for inducing the circulation of the working fluid than the pattern 7. Between the pattern 3 and the pattern 7, there is a big difference in the dissimilarity 1 (d₁) and the dissimilarity 2 (d₂), however, they have a similar thermal performance. Therefore, the thermal performance trend of the PHP having a non-uniform heating pattern cannot be described only by the dissimilarity 1 (d₁) or the dissimilarity 2 (d₂). However, a similar thermal performance can be described by using the effective dissimilarity (d_{eff}), which includes the effects of the two dissimilarities at the same time. As shown in (c) of FIG. 7, the thermal performance of the PHP increases as the effective dissimilarity (d_{eff}) increases. A Pattern 5 has the maximum effective dissimilarity (d_{eff}) and thus has the maximum thermal performance. Therefore, the effective dissimilarity (d_{eff}) proposed in the present disclosure can be used as an appropriate parameter for quantifying the effect of the non-uniform heating pattern in the PHP.

Also, since the thermal performance is determined in proportion to the effective dissimilarity of the channel structure, the effective dissimilarity can be used as a parameter in determining the channel structure for heat dissipation of a local heat source.

Based on the foregoing, it is possible to design a pulsating heat pipe pad for realizing the heat dissipation in the heat source of an electronic device.

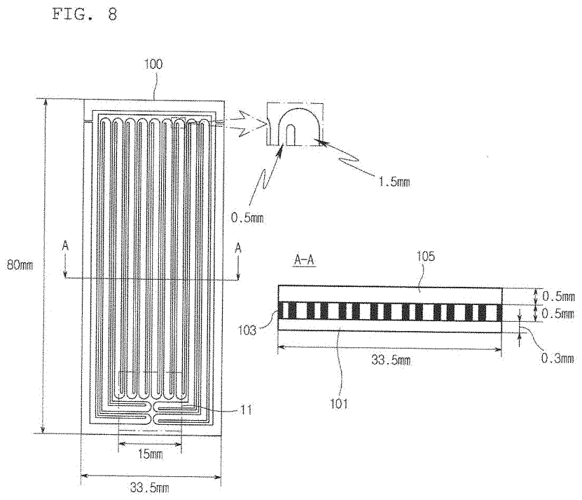

FIG. 8 shows an example of the designed PHP 100.

Referring to FIG. 8, the size of the designed PHP 100 may be 80 mm×33.5 mm. The above size is only an example, and may be variable depending on a device to which the designed PHP 100 is to be mounted.

In the PHP 100, a 0.5 mm-thick silicon substrate 103 may be bonded to a 0.3 mm-thick glass substrate 101. The silicon substrate 103 may be etched to form a passage (channel) through which the pulsating fluid pulsates. In the example of FIG. 8, the silicon substrate may be etched to form 20 interconnected rectangular channels with two different channel widths (e.g., 0.5 mm and 1.5 mm) called double diameter. Accordingly, ten turns may be formed on the heating portion side, and nine turns may be formed on the condensing portion side. Due to the difference in capillary pressure caused by such a double diameter channel, the PHP 100 is able to operate stably even in a horizontal direction. Again, a 0.5 mm-thick glass cover 105 may be bonded to the silicon substrate. Thus, the silicon substrate 103 having the channel may be placed between the glass substrate 101 and the glass cover 105. In the example of FIG. 8, the glass substrate 101 and the glass cover 105 are used to observe the phenomenon. However, it is obvious that other materials can be used.

In the example of FIG. 8, the heating portion 11 is assumed to be a square having one side of 15 mm. However, the heating portion 11 which generates heat may have various shapes and sizes.

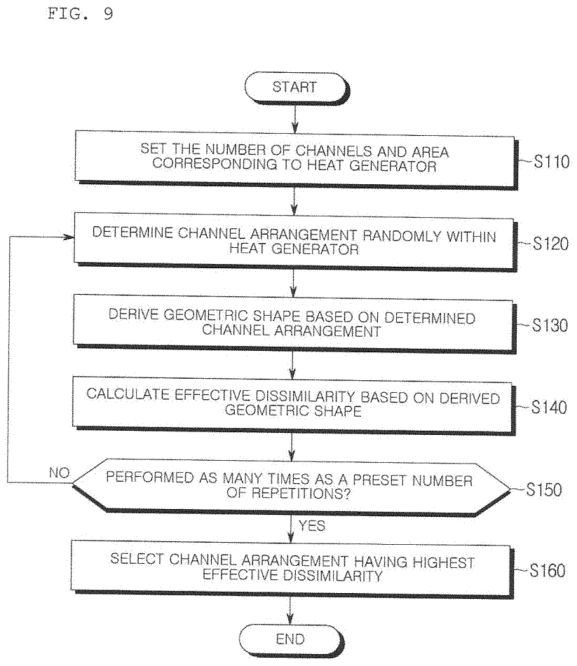

FIG. 9 is a flowchart showing an operation to design the channel structure of the PHP 100.

Referring to FIG. 9, in step S110, the number of channels to be included in the PHP 100 and an area of the PHP 100 corresponding to the heating portion 11 may be set. The number of channels may be determined based on the total size and channel width of the PHP 100. The PHP 100 can dissipate the heat generated from the heating portion. To this end, a specific area of the PHP must be in contact with the heating portion. Accordingly, when the heating portion 11 is identified in the electronic device, an area (heating area) with which the PHP 100 contacts the heating portion may be set in order to dissipate the heat generated from the identified heating portion.

In step S120, channel arrangement within the heating area may be randomly determined. According to the embodiment, the size and position that each channel occupies within the heating portion 11 may be randomly determined based on the size of the heating portion 11. Such a random arrangement may be performed by a random operation of a computer, or may be made by randomly selecting one of the standard arrangements shown in FIG. 4 stored in advance and by modifying the area that each channel occupies in the heating portion in accordance with the size of the heating portion. However, all the channels must be arranged within the heating portion 11.

In step S130, a geometric shape corresponding to the channel arrangement may be derived based on the determined channel arrangement. Derivation of the geometric shape based on the determined channel arrangement may be performed according to the procedure shown in FIG. 3.

In step S140, the effective dissimilarity of the geometric shape of the determined channel arrangement may be calculated. The effective dissimilarity calculation may be performed according to equations 1 and 2.

In order to select channel arrangement having the highest effective dissimilarity, steps S120 to S140 may be repeatedly performed a plurality of times while changing the channel arrangement. To this end, in step S150, the number of times the steps S120 to S140 are repeated may be checked, and it may be determined whether the repetition is performed as many times as a preset number of repetitions.

As a result of the determination, if steps S120 to S140 have not been performed as many times as a preset number of repetitions, steps S120 to S140 are performed again for a new channel arrangement, and if steps S120 to S140 have been performed as many times as a preset number of repetitions, a step S160 may be performed.

In step S160, the effective dissimilarities obtained for various channel arrangements may be compared and then the channel arrangement having the highest effective dissimilarity may be selected.

According to the flowchart shown in FIG. 9, when the shape of the device and the position of the heating portion are determined, the channel structure for heat dissipation of the heating portion adapted accordingly may be determined and the PHP may be manufactured and used.

According to various embodiments, a method for designing the channel structure of the pulsating heat pipe is provided, which may include: setting the number of channels to be included in the pulsating heat pipe and a heating portion of the pulsating heat pipe which is an area in contact with a heat source; determining randomly the arrangement of the channel within the heating portion; deriving a geometric shape corresponding to the determined arrangement of the channel; calculating an effective dissimilarity based on the derived geometric shape; determining whether the determining randomly the arrangement of the channel, the deriving the geometric shape, and the calculating the effective dissimilarity have been performed as many times as a preset number of times of repetition; selecting, when the repetition is performed as many times as the preset number of times of repetition, the channel arrangement of which the effective dissimilarity obtained during the repetition is the greatest among the randomly determined channel arrangements; and determining the selected channel arrangement as a channel structure.

According to various embodiments, the deriving the geometric shape may include forming polygons surrounding a pair of a wide channel and a narrow channel connected by turn in the heating portion, making the polygons found by searching in a clockwise or counterclockwise direction from one polygon selected randomly among the formed polygons rectangular and arranging them sequentially, wherein the area of the rectangle corresponding to the polygon is the same as that of the polygon and deriving the geometric shape by combining the sequentially arranged rectangles.

According to various embodiments, the calculating the effective dissimilarity may include calculating a first dissimilarity based on a difference between a value of a turning function of the geometric shape and a value of a turning function of a rectangular reference channel structure shape, calculating a second dissimilarity based on a difference between the value of the turning function of the geometric shape and a value of a turning function of a right angled triangular reference channel structure shape, and calculating the effective dissimilarity by dividing the first dissimilarity by the second dissimilarity.

According to various embodiments, when the calculated effective dissimilarity is not greater than a threshold value as a result of the determination, the determining randomly the arrangement of the channel within the heating portion, the deriving the geometric shape, the calculating the effective dissimilarity, and the determining whether the calculated effective dissimilarity is greater than the threshold value are repeated.

According to various embodiments, the heat dissipation device may include a PHP having a channel structure designed according to the above-described method.

According to various embodiments, the electronic device may include a heat source which radiates the heat for the operation of the electronic device and may include the heat dissipation device of claim 16 in order to dissipate the heat radiated from the heat source.

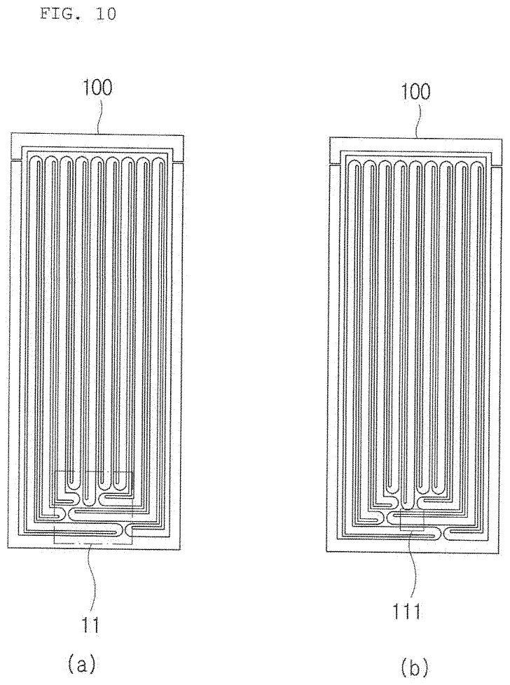

In the case of the local heating, the heat dissipation can be efficiently performed by the non-uniform channel arrangement according to the first embodiment described above. However, since each channel of the PHP has a certain area, there is a limitation that the number of the channels that can be applied is decreased when there is a very small heating portion. FIG. 10 shows an example in which the heating portion 111 has a very small size.

As shown in (a) of FIG. 10, all the channels can contact with the heating portion 111 when a heating portion 11 has a certain size. However, as shown in (b) of FIG. 10, when the size of the heating portion 111 is very small, it may be impossible to arrange all the channels in such a way as to contact with the heating portion 111. In this case, the channel not in contact with the heating portion 111 cannot receive the heat and thus pulsation is not effectively performed, and as a result, the thermal performance of the PHP may be degraded.

In order to solve the problem of the first embodiment described above, a second embodiment of the present disclosure proposes a channel arrangement method in which the PHP operates normally even with respect to a very small heating portion.

The PHP according to the second embodiment of the present disclosure may be a PHP having a channel structure designed such that at least some channels of a plurality of channels of conventional PHP shown in FIG. 1 are merged and a half or over of the plurality of channels overlap at least partially with a heating portion. Here, the plurality of channels is connected from a heating portion to a condensing portion to move heat from the heating portion to the condensing portion.

For effective channel arrangement, the second embodiment simplifies the channel design problem as a heat conduction path design problem based on a reasonable assumption that the working fluid of all the channels perform the active pulsating motion in consideration of the characteristics of the PHP.

The heat conduction path may be designed based on a topology optimization method.

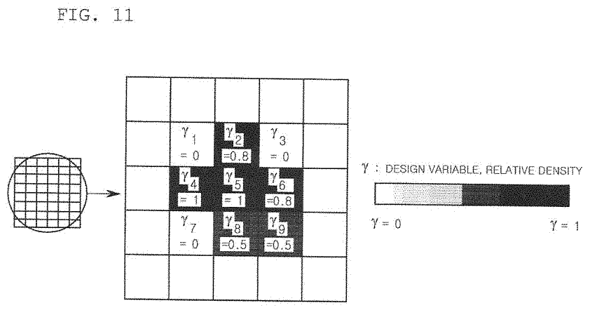

FIG. 11 is a view for describing a topology optimization method.

The topology optimization method refers to optimally designing a topology corresponding to the geometrical contour in the conceptual design step of the PHP, and is, from an engineering perspective, an analysis method for finding an optimal shape which satisfies not only the performance objective of the PHP but also a given boundary condition. Therefore, in order to use the topology optimization method, an objective function representing a performance objective and various constraints accompanying the objective must be set. In addition, variables to be designed to achieve the performance objective are referred to as design variables, and the search for the direction of the design variable for finding an optimal design is referred to as a sensitivity analysis.

In the present disclosure, the topology optimization method applied to determine a channel path divides a specific design area into a large number of elements, and determines a relative density γ representing a value that shows whether each element area is filled with a specific material or is empty. Here, the element area having the relative density γ greater than a specific threshold value (e.g., 0.9) may be an area where the channel is located. The relative density is a variable of the topology optimization method and may be determined at each element of the design area such that the objective function is minimized or maximized during the optimization operation.

The structure of the PHP has its simple structure because it includes only a passage in the channel through which the pulsating fluid can pulsate. However, the structure of the PHP has a complex physical phenomenon accompanying a phase change in which the working fluid receives the heat from the heating portion to become a gas and then becomes liquid while proceeding to the condensing portion. Therefore, there is no governing equation capable of explaining the entire system, so that there is a limit to directly apply the structure of the PHP to the topology optimization. Accordingly, when the working fluid pulsates actively in all the channels of the PHP, the channel portion may be approximated to a solid material having high thermal conductivity based on the fact that the heat is transferred along a path in which the working fluid pulsates, that is, the channel. Then, the channel portion can be replaced with a high thermal conductivity solid material having a high relative density γ and the wall portion forming the channel can be replaced with a low thermal conductivity material having a low relative density γ. Through such replacement, the channel structure design problem of the PHP can be replaced with a thermal conduction path design problem. The topology optimization method can be applied to find an optimized thermal conduction path.

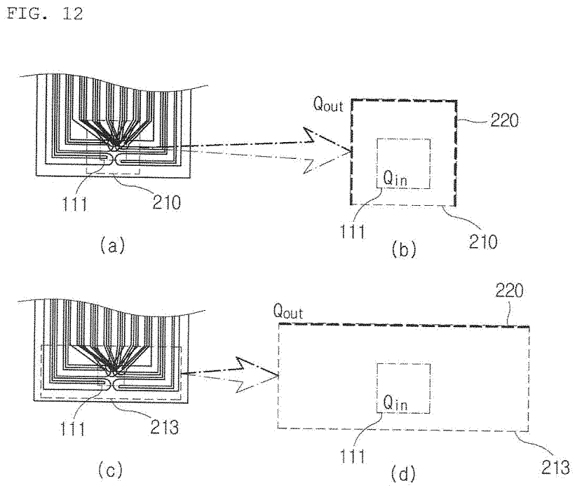

FIG. 12 shows an example of setting the boundary condition and the design area applied to the topology optimization method for the thermal conduction path design.

When the heating portion 111 has a small size, the channels must overlap each other in order for all the channels to contact with the heating portion 111. Accordingly, a portion of the PHP including an area in which the channels may overlap may be set as the design areas 210 and 213, and an area other than the design area of the PHP may be replaced with the condensing portion. Since each channel in the area corresponding to the condensing portion can be assumed to have the same area, it can be said that all the channels have the same heat output Qₒᵤₜ. Therefore, the topology optimization method may be an optimization method to find, in the design areas 210 and 213, channel paths for dispersing the heat input Qᵢₙ coming from the heating portion 111 through the channels having the same heat output Qₒᵤₜ. In (b) or (d) of FIG. 12 in which the design area is enlarged, the outer thick line may be the output 220 of each channel. That is, the output position of the channel may be changed according to the setting of the design area, and the boundary condition may be changed accordingly.

FIG. 12 shows, as an example, that the heating portion is located at the center of the lower portion of the PHP. According to another embodiment, the heating portion 111 may be located in any area within the PHP. For example, the heating portion 111 may be located at the center of the PHP, or may be located at the edge such as the upper left, upper right, lower left, lower right, and the like. Accordingly, it is possible to set the design area based on the heating portion 111 located in any area and to set the boundary condition accordingly.

The governing equation and boundary condition of the design area shown in (b) or (d) of FIG. 12 are as shown in equation 3 below.

$$∇ \cdot ( k ∇ T ) + b = 0 \\ - ( k ∇ T ) \cdot n = 0 on {Γ}_{ins} \\ - ( k ∇ T ) \cdot n = q on {Γ}_{cond} \qquad [ Equation 3 ]$$

Here, k is the thermal conductivity, b is an internal heating power Qᵢₙ, and q is a heat flux at a condensing portion boundary surface 220, that is, a place where the channel is formed at the edge of the design area, Γᵢₙₛ is an insulating boundary and Γ_{cond} is a constant heat flux boundary.

When the governing equation is discretized by finite element method (FEM), a linear system for calculating the temperature at each element of the following equation 4 can be obtained.

$$T = {K}^{- 1} f \\ K = {\int }_{Ω} {B}^{T} D B d Ω \\ f = b {\int }_{{Ω}_{exp}} {N}^{T} d Ω - q {\int }_{{Γ}_{cond}} {N}^{T} d T \\ D = k ( γ ) {I}_{2} \qquad [ Equation 4 ]$$

Here, K is a thermal stiffness matrix, T is a temperature vector, and f is a thermal load vector. B is a differential matrix of f, D is a thermal conductivity matrix, and N is a shape function matrix defined through interpolation in order to obtain values between the elements.

When a thermal conductivity is assigned to each element in the design area, an effective thermal conductivity according to the relative density γ can be determined as shown in equation 5 below by using a penalization approach.

k(γ)=(k_{eff}−kₛᵢ)γ^{p}+kₛᵢ [Equation 5]

Where kₛᵢ is the thermal conductivity of silicon, k_{eff} is the effective thermal conductivity of the channel, γ is the relative density of the element, and p is a penalty factor. According to the embodiment, since the PHP may be made of a silicon substrate, a channel wall constituting the channel in the design area may have a thermal conductivity kₛᵢ of silicon. The effective thermal conductivity k_{eff} of the channel means the thermal conductivity of a solid in the design area, which means the channel of the PHP. The effective thermal conductivity k_{eff} of the channel in the PHP may vary depending on various parameters such as working fluid, channel configuration and length. According to previous studies on the silicon-based PHP, the channel portion of the PHP may have an effective thermal conductivity between 1000 and 4000 W/m·K. Since the effective thermal conductivity k_{eff} of the channel is much higher than the thermal conductivity kₛᵢ of silicon, the thermal conductivity kₛᵢ of silicon have no choice but to affect the final design. The penalty factor p helps to suppress the median density, and may have a value of 3.0 according to the embodiment.

The objective function for solving the thermal conduction path optimization problem in consideration of the characteristics of the PHP is shown in equation 6 below, and the constraint is shown in equation 7 below.

$$\begin{matrix}min \text{:} c ( γ ) = {T}^{T} f & [ Equation 6 ] \\ 0 < {γ}_{min} \leq γ \leq 1 \\ {( \frac{d c}{d γ} )}^{*} = F ( \frac{d c}{d γ} ) \\ 1 - \frac{{\int }_{Ω} γ ( x ) }{{γ}_{Ω}} \geq {f}_{0} \\ G \leq 0 & [ Equation 7 ]\end{matrix}$$

Here, c is thermal compliance, γ_{Ω} is the total area of the design area, f₀ is a void volume fraction, F is a sensitivity filter, and G is a local void volume constraint. The void may be a portion that becomes the channel wall in order to form the channel within the design area.

The thermal compliance is widely used as an objective function for heat transfer problems. The thermal compliance may be defined as a product of a temperature distribution and a heat load. Minimizing the thermal compliance under a certain heat flux boundary condition minimizes a difference between an average temperature of the heating portion and a temperature of the condensing portion in the design area. For each element in the design area, the sensitivity of the objective function of the relative density γ is given in equation 8 below.

$$\frac{\partial c}{\partial {γ}_{i}} = \frac{\partial {T}^{T}}{\partial {γ}_{i}} KT + {T}^{T} \frac{\partial f}{\partial {γ}_{i}} \qquad [ Equation 8 ]$$

The sensitivity of equation 8 may be calculated by using an adjoint method, and the sensitivity may be obtained according to equation 9 below.

$$\frac{\partial c}{\partial {γ}_{i}} = - {T}^{T} \frac{\partial K}{\partial {γ}_{i}} T = - \frac{\partial k ( {γ}_{i} )}{\partial {γ}_{i}} {T}^{T} {BI}_{2} BT \qquad [ Equation 9 ]$$

The constraint of equation 7 may be applied so as to consider the characteristics of the PHP. The PHP transfers heat by the pulsating motion of the working fluid, and the principle of the pulsating motion in the PHP is known as pressure propagation resulting from a pressure difference between adjacent vapor plugs. Therefore, when the channels are merged through a junction, the pressure difference is uneven and a driving force for the pulsating motion of the liquid slug may be reduced. Therefore, the PHP must be composed of connected channels, and must not be merged in the heating portion. This characteristic can be implemented through the constraint of equation 7.

In order to form the channel arrangement structure in the design area, a sensitivity filter and a total void volume constraint need to be applied. The sensitivity filter, which is also referred to as a member-sizing filter, is shown in T S Kim, J E Kim, J H Jeong, Y Y Kim, Filtering technique to control member size in topology design optimization, KSME Int. J. (2004)). The filter is used to adjust a solid material portion in a domain to the width size of the channel. A total void volume constraint may be applied for the structural stability. The channel wall in the PHP serves to stably maintain the channel structure. Therefore, for a stable channel configuration, a total void volume fraction which means the channel wall portion is limited to have a value equal to a total void volume fraction (e.g., f₀=0.32) of the uniform channel structure shown in FIG. 1.

The local void volume local constraint helps to suppress the merging of channels in the heating portion 111. The local area constraint ensures that the void, which means the channel wall, is minimized in each local area.

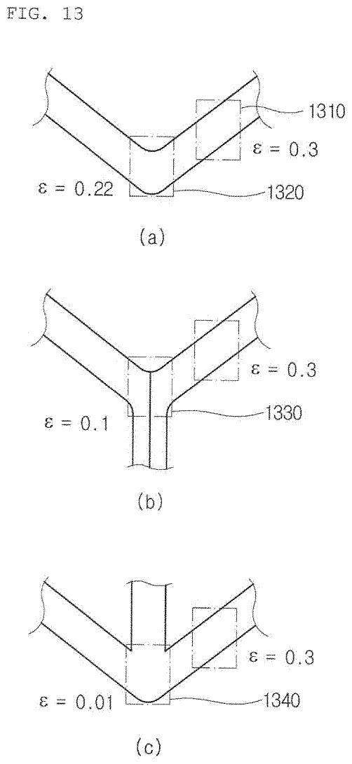

FIG. 13 shows an example of an operation method of the local void volume constraint.

Referring to FIG. 13, the local area is set to a square 30% larger than the channel width. For all elements, the void fraction c of each local area is calculated. In the local area 1310 and the local area 1320 in (a) of FIG. 13, the void fractions are 0.3 and 0.22, respectively. If the minimum void fraction in each local area is set to 0.2, the solid material distribution shown in (a) of FIG. 13 satisfies the local void volume local constraint and may not be modified by this constraint because the void fractions in the local area 1310 and the local area 1320 in (a) of FIG. 13 is larger than the minimum void fraction. However, as shown in (b) and (c) of FIG. 13, the void fractions in the local area 1330 and the local area 1340 where the channels are merged are 0.1 and 0.01, respectively. Since the void fractions in the local area 1330 and the local area 1340 is smaller than the minimum void fraction, the channel distribution shown in (b) and (c) of FIG. 13 does not satisfy the local void volume constraint and must be complemented. The local void volume constraint may be represented as equation 10 below.

$${g}_{e} = {ɛ}_{0} - \frac{{\sum }_{k ∈ {Ω}_{e}} ( 1 - ρ )}{{Ω}_{e}} \leq 0 , e ∈ Φ \qquad [ Equation 10 ]$$

Here, e represents the local area and Φ represents the design area. ε₀ represents the minimum void fraction, and may be set to 0.2 according to the embodiment. Ωₑ represents the size of the local area, and may be set to 1.3 times the channel width according to the embodiment.

$${\sum }_{k ∈ {Ω}_{e}} ( 1 - ρ )$$

represents the size of the void in the local area.

In order to satisfy the local void volume constraint, since it is necessary to determine the condition that the gₑ value of equation 10 is less than 0 in all local areas, a large computational cost may be required. Therefore, if an aggregation strategy for reducing the computational cost is used, the condition of equation 10 in all local areas may be collected as a single condition represented as equation 11 below.

$$max \{ g \} \approx G = {\{ \frac{1}{{N}_{t}} ( {\sum }_{i = 1}^{{N}_{t}} {( {g}_{i} + 1 - {ɛ}_{0} )}^{n} ) \}}^{1 / n} - 1 + {ɛ}_{0} \leq 0 \qquad [ Equation 11 ]$$

Here, Nₜ represents the total number of local areas, gᵢ is a value obtained by subtracting the void fraction of the i-th local area from the minimum void fraction as shown in equation 10, and n is an index for controlling the accuracy of aggregation.

As described above, the channel design problem for effective heat dissipation of the PHP can be simplified to a design problem of a thermal conduction path when the channel portion is assumed to be a solid having high thermal conductivity. Thus, the distribution of the solid in the design area may represent the channel portion that is the through path of the liquid slug.

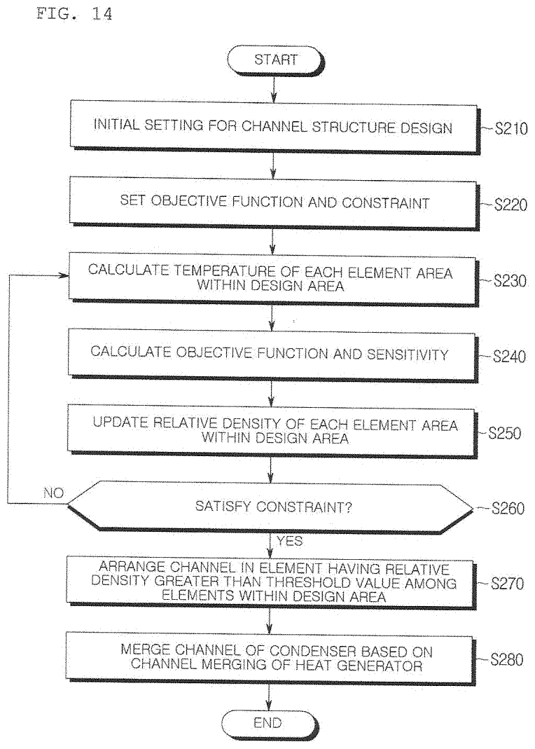

FIG. 14 shows a method for designing the channel structure of the pulsating heat pipe based on the topology optimization method.

Referring to FIG. 14, in step S210, an initial setting for designing the channel structure of the PHP may be performed. The initial setting may include the design area, the boundary condition, and a heating portion setting.

The heating portion may be an area which contacts the heat source that generates heat to be dispersed by the pulsating heat pipe. The heating portion setting may be the size of the heat input Qin flowing from the heating portion to the design area and the location of the heating portion. The location of the heating portion may be any area within the PHP. For example, the location of the heating portion may be the middle of the lower portion as shown in FIG. 12, or may be the center of the PHP, or may be the edge such as the upper left, upper right, lower left, lower right, etc.

The design area may be an area set to design the channel structure around the heating portion.

In general, when the size of the PHP having a uniform channel shape shown in FIG. 1 is determined, the number of the channels may be determined based on the width of the channel. However, when the size of the heating portion is small, the channels must overlap each other in order that all the channels contact with the heating portion as shown in FIG. 12. Such an area where the channels overlap or a wider area including the area where the channels overlap may be set to a design area for channel structure design. In addition, a channel that becomes a passage through which the heat can be dissipated may be at the interface surface of the design area. It may be assumed that the heat output Qout in each of these channels is the same. Accordingly, as the boundary condition, an area of the boundary surface, which corresponds to the channel has a constant heat output, and an area corresponding to the channel wall other than the channel can be set to the heat output of silicon. In general, the heat output in the area corresponding to the channel may be much larger than the heat output in the area corresponding to the channel wall.

Also, in the initial setting, the design area may be divided into a plurality of element areas. For example, the design area may be divided into 132×141=18612 square element areas. The subsequent optimization operation is to determine the relative density of each element area, and the element area having a relative density greater than a threshold value may be a portion where the channel is arranged.

In step S220, the objective function and the constraint for designing the channel structure may be set.

The objective function is to minimize a difference between an average temperature of the heating portion and a temperature of the condensing portion (the boundary of the design area) in the design area as shown in equation 6, and is to find a relative density in each element area, which minimizes a value of the thermal compliance defined as a product of the temperature distribution and the heat load.

The constraint may be represented as equation 7.

If the channels are merged as one in the design area where the channels overlap, there is no pressure difference between the channels, and the driving force of the working fluid for the pulsating motion of the liquid slug may be reduced. Therefore, the constraint of equation 7 implements the feature that the channels must be connected for active pulsating motion of the liquid slug in the channel and must not be merged in the heating portion.

The first constraint in equation 7 is a general thing that the relative density has a value between 0 and 1.

The second constraint in equation 7 represents the sensitivity filter, and may perform a function of controlling the channel width which is set in the design area to a preset channel width (e.g., 1 mm).

The third constraint of equation 7 is the void volume constraint, and the total void volume fraction which means the channel wall portion is constrained to have a set value (e.g., f₀=0.32) for the structural stability of the PHP.

The fourth constraint of equation 7 may be used to suppress the merging of channels in the heating portion, as the local void volume constraint. The operating method of the local void volume constraint is described in more detail in FIG. 13.

In step S230, the temperature distribution of the plurality of element areas may be obtained based on the relative density in each element area of the design area set in step S210. The obtainment of the temperature distribution may be performed based on equation 4. Based on equation 4, the temperature of each element area may be calculated based on the relative density of each element area. Here, the first relative density γ of each element area may be set to 1 for the element area in a portion other than the heating portion 111 and may be set to 0 for the element area in a portion included in the heating portion 111. Then, the temperature of each element area can be calculated based on the updated relative density γ.

In step S240, the objective function and the sensitivity of the objective function set in step S220 may be calculated. Here, the sensitivity of the objective function may be calculated according to equation 9.

In step S250, the relative density 7 may be updated by finding a new relative density γ value by performing topology optimization which depends on the constraint set in step S220 and minimizes the thermal compliance by solving the objective function and. According to the embodiment, the optimization method may use a method of moving asymptotes (MMA) which is generally used in the topology optimization. The MMA is a method for general nonlinear programming and especially for structural optimization. The MMA approaches the final solution by generating and solving a strict convex approximation subproblem in each step of the repeated operation. Here, the generation of the subproblem is controlled by so-called moving asymptotes, which can stabilize and accelerate the convergence of general motions.

In step S260, it is determined whether the constraint of equation 7 is satisfied.

If the constraint of equation 7 is not satisfied, the process returns to step S220 and the temperature of each element area in the design area may be calculated again based on the relative density updated in step S240. In addition, steps S230, S240, and S250 may be repeatedly performed until the constraint in equation 7 is satisfied.

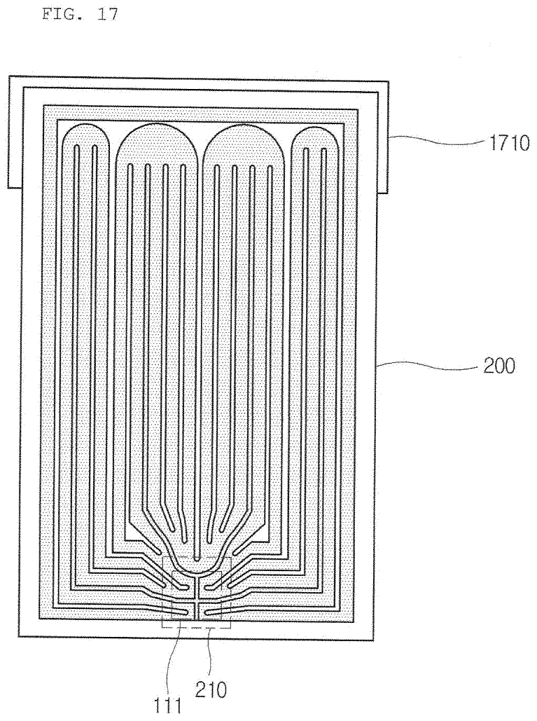

If the constraint of equation 7 is satisfied, in step S270, the channel wall may be arranged in the element area having a relative density smaller than a threshold value (e.g., 0.9) among the element areas within the design area. Then, the channel may be formed in the element area having a relative density greater than the threshold value among the element areas within the design area. Here, as shown in FIG. 16 or 17 of an example to be described later, several channels may be merged in order that all the channels initially set contact with the heating portion. Accordingly, the channel arrangement structure in the design area can be completed.

In step S280, the channel merging of the condensing portion may be performed based on the channel merging in the design area. For example, as shown in FIG. 17, when the channels in the design area are merged to have only five turns, the channels of the condensing portion may also be merged to have only 4 turns.

In step S280, the PHP may be manufactured based on the channel arrangement structure determined by the above-described steps. The manufacture may be performed according to the above description for describing FIG. 8.

According to another embodiment, even if the constraint of step S260 is not satisfied, the change value of the relative density may not be large when the number of repetitions of steps S230 to S250 is sufficient. Accordingly, when the change value becomes smaller than a specific value (for example, 0.001), the process leaves the repeat loop, and the steps S270 and S280 may be performed regardless of whether the constraint of step S260 is satisfied.

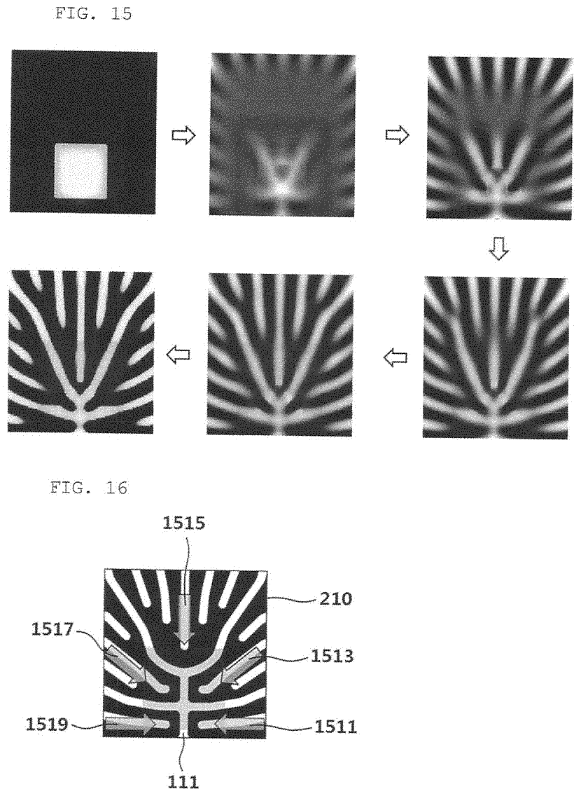

FIGS. 15 to 17 are views showing an example of forming the channel arrangement structure based on the topology optimization method. FIG. 15 shows a history of a relative density distribution which appears during the optimization. FIG. 16 shows the channel arrangement according to a topology optimization result in the design area 210. FIG. 17 shows the pulsating heat pipe 200 in which the channel arrangement has been made based on the topology optimization method.

As shown in FIG. 15, the distribution of the relative density is updated to satisfy the objective function and the constraint while performing the topology optimization, and finally, a channel arrangement as shown in FIG. 16 may be obtained.

As shown in FIG. 16, some channels are merged to contact with the area of the heating portion 111, and several separate channels are formed in the area of the heating portion 111 in order to make a pressure difference between adjacent vapor plugs. Originally, in the uniform channel arrangement structure of nine turns (18 channels), in order for all the channels to contact with the heating portion 111, several channels are partially overlapped in the heating portion 111. However, in the case of the channel arrangement structure based on the topology optimization, nine turns are merged into five turns as shown in FIG. 16. That is, 18 channels are merged into 10 channels, and all the channels contact partially with the heating portion 111.

When the number of turns in the heating portion 111 is reduced in the channel structure of the pulsating heat pipe obtained based on the topology optimization, it is necessary to reconstruct the number of turns in a condensing portion 1710 in consideration of a pressure transmission direction. As described above, pressure propagation resulting from a pressure difference between adjacent vapor plugs is an operating principle of the pulsating motion generated in the PHP. In the case of the uniform channel arrangement, there are nine turns in the heating portion and eight turns in the condensing portion. Since the uniform channel arrangement structure is a closed loop, pressure can be transmitted naturally to the next channel. Meanwhile, in the case of the channel structure of the PHP obtained based on the topology optimization, since the channels are merged with five turns, the pressure propagation also occurs in the directions (1511, 1513, 1515, 1517, and 1519) shown in FIG. 16. For this pressure transmission direction, the channels of the condensing portion 1710 need to be merged with four turns as shown in FIG. 17.

As illustrated in FIG. 17, by using the topology optimization method, it is possible to design the arrangement structure which causes all the channels of the PHP to contact with the heating portion 111 even if the size of the heating portion 111 is small. Therefore, even when the size of the heating portion 111 is very small, it is possible to design the PHP capable of efficiently dissipating the heat.

According to various embodiments, a method for designing the channel structure of the pulsating heat pipe includes designing a channel structure such that at least some channels of a plurality of channels are merged and a half or over of the plurality of channels overlap at least partially with a heating portion, wherein the plurality of channels connects the heating portion and a condensing portion.

According to various embodiments, the designing the channel structure includes performing an initial setting including setting a heating portion, setting a design area for designing a channel structure around the heating portion, setting a boundary condition of the design area, dividing the design area into a plurality of element areas, and setting a relative density for each of the plurality of element areas as an optimization parameter; setting an objective function for minimizing a temperature difference between the heating portion and the boundary of the design area, a relative density constraint that the relative density has a value greater than or equal to 0 and is less than or equal to 1, a sensitivity filter for controlling a channel width which is set within the design area to a predetermined channel width, a void volume constraint that a total void volume fraction which means a channel wall portion must be greater than a predetermined value for the purpose of structural safety of the pulsating heat pipe, and a local void volume constraint for suppressing the merging of the channel in the heating portion; obtaining a temperature distribution vector of the plurality of element areas based on each of the element areas; calculating the object function and a sensitivity of the objective function; updating the relative density of the plurality of element areas by performing optimization based on the set constraints and the set objective function, and finding a new relative density which minimizes thermal compliance; determining whether the relative density constraint, the sensitivity filter, the void volume constraint and the local void volume constraint are satisfied; calculating again, when the constraints are not satisfied, temperatures in the plurality of element areas based on the updated relative density; arranging, as the channel wall, when the set constraint is satisfied, the element areas where the relative density is less than a threshold value among the plurality of element areas; and merging the channel of the condensing portion based on the merging of the channel created by arranging the channel wall.

According to various embodiments, the objective function is defined as a product of a temperature distribution and a heat load and is represented as an equation. Here, T is the temperature distribution vector of the plurality of element areas, and f is a heat load vector of the plurality of element areas.

According to various embodiments, the temperature distribution vector and the heat load vector are obtained based on equations

$$T = {K}^{- 1} f , K = {\int }_{Ω} {B}^{- T} D B d Ω , \\ f = b {\int }_{{Ω}_{exp}} {N}^{T} d Ω - q {\int }_{{Γ}_{cond}} {N}^{T} d Γ ,$$

and, D=k(γ)I₂, Here, K is a thermal stiffness matrix,

B is a differential matrix of the temperature distribution vector f, D is a thermal conductivity matrix, N is a shape function matrix, and I₂ is a 2×2 unit matrix.

According to various embodiments, the sensitivity

$$\frac{\partial c}{\partial {γ}_{i}}$$

of the objective function is obtained by

$$\frac{\partial c}{\partial {γ}_{i}} = - {T}^{T} \frac{\partial K}{\partial {γ}_{i}} T = - \frac{\partial k ( {γ}_{i} )}{\partial {γ}_{i}} {T}^{T} {BI}_{2} BT .$$

According to various embodiments, the void volume constraint is implemented by

$$1 - \frac{{\int }_{Ω}^{ } γ ( x )}{{γ}_{Ω}} \geq {f}_{0} ,$$

wherein the local void volume constraint is implemented by

$${\{ \frac{1}{{N}_{t}} ( {\sum }_{i = 1}^{{N}_{t}} {( {g}_{i} + 1 - {ɛ}_{0} )}^{n } ) \}}^{1 / n} - 1 + {ɛ}_{0} \leq 0.$$

Here, γ_{Ω} represents a total area of the design area and is the number of the plurality of element areas in the design area, f₀ is a preset reference void volume fraction, ∫₁₀₆ γ(x) is a value obtained by summing all the relative densities of the plurality of element areas, and Nt is the number of local areas in the design area, ε₀ is a minimum void fraction, and gᵢ is a value obtained by subtracting the void fraction of an i-th local area from the minimum void fraction.

According to various embodiments, t the merging the channel of the condensing portion based on the merging of the channel created by arranging the channel wall includes merging the channels of the condensing portion such that the number of turns of the condensing portion is one less than the number of turns obtained by the merging the channel created by arranging the channel wall.

According to various embodiments, the determining whether the relative density constraint, the sensitivity filter, the void volume constraint and the local void volume constraint are satisfied may include determining whether a difference value between the updated relative density and a previous relative density is less than a preset threshold value even if the constraints are not satisfied, wherein, if it is determined that the difference value between the updated relative density and the previous relative density is less than the preset threshold value, performing the arranging, as the channel wall, the element areas where the relative density is less than the threshold value among the plurality of element areas and the merging the channel of the condensing portion based on the merging of the channel created by arranging the channel wall are performed.

According to various embodiments, a pulsating heat pipe may comprise a channel structure designed such that at least some channels of a plurality of channels are merged and a half or over of the plurality of channels overlap at least partially with a heating portion, wherein the plurality of channels connects the heating portion and a condensing portion.

According to various embodiments, a heat dissipation device may include a pulsating heat pipe having a channel structure designed such that at least some channels of a plurality of channels are merged and a half or over of the plurality of channels overlap at least partially with a heating portion corresponding to a heat source which radiates heat.

According to various embodiments, the electronic device may include a heat source which radiates heat for operations thereof and a heat dissipation device comprising a pulsating heat pipe having a channel structure designed such that at least some channels of a plurality of channels are merged and a half or over of the plurality of channels overlap at least partially with a heating portion, wherein the heat dissipation device is positioned around the heat source such that the heating portion of the pulsating heat pipe corresponds to the heat source.

The above-described method or the operation of an algorithm may be directly implemented by hardware and software modules that are executed by a processor or may be directly implemented by a combination thereof. The software module may be resident on a RAM, a flash memory, a ROM, an EPROM, an EEPROM, a resistor, a hard disk, a removable disk, a CD-ROM, or any other type of record medium known to those skilled in the art. An exemplary record medium is coupled to a processor and the processor can read information from the record medium and can record the information in a storage medium. In another way, the record medium may be integrally formed with the processor. The processor and the record medium may be resident within an application specific integrated circuit (ASIC). The ASIC may be resident within a user's terminal.

1. A method for designing a channel structure of a pulsating heat pipe, the method comprising:
designing a channel structure such that at least some channels of a plurality of channels are merged and a half or over of the plurality of channels overlap at least partially with a heating portion, wherein the plurality of channels connects the heating portion and a condensing portion.

2. The method of claim 1,
wherein the designing the channel structure comprises:
performing an initial setting including setting a heating portion, setting a design area for designing a channel structure around the heating portion, setting a boundary condition of the design area, dividing the design area into a plurality of element areas, and setting a relative density for each of the plurality of element areas as an optimization parameter;
setting an objective function for minimizing a temperature difference between the heating portion and the boundary of the design area, a relative density constraint that the relative density has a value greater than or equal to 0 and is less than or equal to 1, a sensitivity filter for controlling a channel width which is set within the design area to a predetermined channel width, a void volume constraint that a total void volume fraction which means a channel wall portion must be greater than a predetermined value for the purpose of structural safety of the pulsating heat pipe, and a local void volume constraint for suppressing the merging of the channel in the heating portion;
obtaining a temperature distribution vector of the plurality of element areas based on each of the element areas;
calculating the object function and a sensitivity of the objective function;
updating the relative density of the plurality of element areas by performing optimization based on the set constraints and the set objective function, and finding a new relative density which minimizes thermal compliance;
determining whether the relative density constraint, the sensitivity filter, the void volume constraint and the local void volume constraint are satisfied;
calculating again, when the constraints are not satisfied, temperatures in the plurality of element areas based on the updated relative density;
arranging, as the channel wall, when the set constraint is satisfied, the element areas where the relative density is less than a threshold value among the plurality of element areas; and
merging the channel of the condensing portion based on the merging of the channel created by arranging the channel wall.

3. The method of claim 2,
wherein the objective function is defined as a product of a temperature distribution and a heat load and is represented as an equation c(γ)=T^{T}f,
and wherein T is the temperature distribution vector of the plurality of element areas, and f is a heat load vector of the plurality of element areas.

4. The method of claim 3,
wherein the temperature distribution vector and the heat load vector are obtained based on equations T=K⁻¹f,
$$K = {\int }_{Ω}^{ } {B}^{T} D B d Ω , \\ f = b {\int }_{{Ω}_{exp}} {N}^{T} d Ω - q {\int }_{{Γ}_{cond}} {N}^{T} d Γ ,$$
and D=k(γ)I₂,
and wherein K is a thermal stiffness matrix, B is a differential matrix of the temperature distribution vector f, D is a thermal conductivity matrix, N is a shape function matrix, and I₂ is a 2×2 unit matrix.

5. The method of claim 4, wherein the sensitivity
$$\frac{\partial c}{\partial {γ}_{i}}$$
of the objective function is obtained by
$$\frac{\partial c}{\partial {γ}_{i}} = - {T}^{T} \frac{\partial K}{\partial {γ}_{i}} T = - \frac{\partial k ( {γ}_{i} )}{\partial {γ}_{i}} {T}^{T} {BI}_{2} BT .$$

6. The method of claim 4, wherein the void volume constraint is implemented by
$$1 - \frac{{\int }_{Ω}^{ } γ ( x )}{{γ}_{Ω}} \geq {f}_{0} ,$$
wherein the local void volume constraint is implemented by
$${\{ \frac{1}{{N}_{t}} ( {\sum }_{i = 1}^{{N}_{t}} {( {g}_{i} + 1 - {ɛ}_{0} )}^{n } ) \}}^{1 / n} - 1 + {ɛ}_{0} \leq 0 ,$$
and wherein γ_{Ω} represents a total area of the design area and is the number of the plurality of element areas in the design area, f₀ is a preset reference void volume fraction, ∫_{Ω}γ(x) is a value obtained by summing all the relative densities of the plurality of element areas, and Nt is the number of local areas in the design area, ε₀ is a minimum void fraction, and gᵢ is a value obtained by subtracting the void fraction of an i-th local area from the minimum void fraction.

7. The method of claim 2, wherein the merging the channel of the condensing portion based on the merging of the channel created by arranging the channel wall includes merging the channels of the condensing portion such that the number of turns of the condensing portion is one less than the number of turns obtained by the merging the channel created by arranging the channel wall.

8. The method of claim 2,
wherein the determining whether the relative density constraint, the sensitivity filter, the void volume constraint and the local void volume constraint are satisfied includes:
determining whether a difference value between the updated relative density and a previous relative density is less than a preset threshold value even if the constraints are not satisfied,
wherein, if it is determined that the difference value between the updated relative density and the previous relative density is less than the preset threshold value,
performing the arranging, as the channel wall, the element areas where the relative density is less than the threshold value among the plurality of element areas and the merging the channel of the condensing portion based on the merging of the channel created by arranging the channel wall are performed.

9. A pulsating heat pipe comprising a channel structure designed such that at least some channels of a plurality of channels are merged and a half or over of the plurality of channels overlap at least partially with the heating portion, wherein the plurality of channels connects the heating portion and a condensing portion.

10. The pulsating heat pipe of claim 9, wherein that at least some channels of a plurality of channels are merged and a half or over of the plurality of channels overlap at least partially with the heating portion.

11. A heat dissipation device comprising a pulsating heat pipe having a channel structure designed such that at least some channels of a plurality of channels are merged and a half or over of the plurality of channels overlap at least partially with a heating portion corresponding to a heat source which radiates heat.

12. The heat dissipation device of claim 10, wherein at least some channels of a plurality of channels are merged and the half or over of the plurality of channels overlap at least partially with the heating portion corresponding to the heat source which radiates heat.
